(19) United States
(12) Patent Application Publication
(10) Pub. No.: US 2006/0214378 A1
(43) Pub. Date: Sep. 28, 2006

(54) Brush seal with spiral groove back plate

(76) Inventor: Xiaoqing Zheng, East Greenwich, RI (US)

Correspondence Address: Iandiorio & Teska, 260 Bear Hill Road, Waltham, MA, 02451-1018, US

(21) Appl. No.: 11/091,271

(22) Filed: Mar. 28, 2005

(51) Int. Cl. F16J 15/44

(52) U.S. Cl. 277/355

(57) ABSTRACT

A brush seal includes a plurality of bristles, a front plate, and a back plate abutting the bristles, the back plate including at least one spiral groove therein to pressure balance the brush seal.

### FIELD OF THE INVENTION

This invention relates to an improved brush seal, and more particularly to such a brush seal which has a spiral groove back plate for bristle support and exhibiting an improved pressure balance.

### BACKGROUND OF THE INVENTION

Brush seals are used to provide sealing between stationary and rotating parts, such as a stationary housing and a rotating shaft. Typically, the bristles are sandwiched between front and back plates. The brush seal bristles are fixed and/or attached at one end, namely, at the outer diameter (OD). The other end of the bristles at the inner diameter (ID) constitutes the free sealing end which rides on the rotating shaft, for example, to provide the seal. A brush seal can beneficially accommodate excursions, or relative radial movement between the fixed and rotating components, because of the flexure of the brush seals.

During operation of the device in which the brush seal is employed, the pressure difference across the seal causes a pressure imbalance across the bristles. There is a higher pressure region on the upstream, or front facing bristles, and the direction of the pressure is toward the back plate. The back plate supports the bristles against this pressure.

Conventional brush seals do have limitations, however, in certain applications. One limitation is the lack of capability to withstand high pressure without bristle damage and/or increased seal leakage. Under large pressure loads, the bristles are washed down by the airflow and pressed against the back plate, making the bristle pack very stiff. The bristles lose the radial flexibility because of the increased bristle pack stiffness and large friction force between the bristles and the backplate. As a result, the bristle pack is in heavy contact with the rotating shaft. The bristles undergo greatest pressure at the bottom of the back plate nearest the ID, with severe bending of the bristles as a consequence. If the shaft is undergoing an excursion in the radial direction toward the OD, the bristles can be subjected to severe wear because of pressure from the rotating shaft at the free sealing end. Thereafter, when excursion of the rotating shaft is in the opposite direction such that there is less pressure at the free sealing of the bristles, the bristles do not fully return to the initial sealing position because of wear and frictional forces. Thus, shaft excursions in high pressure applications result in severe wear of the bristles, extensive air leakage following excursions, and decreased effectiveness of the brush seal because of these effects.

Various ways to create a better pressure balanced brush seal design have been explored. One method includes multiple circular grooves in the back plate. However, pressures in these separate grooves is unequal, it cascades down from outer grooves to inner groove and thus this design is less than ideal. Another method includes a cavity in the back plate on the bristle side to extend the high pressure region over a larger bristle area. With such a cavity, the high pressure area on the back plate extends toward the ID, resulting in a better pressure-balanced design. Theoretically, the wider the back plate cavity or groove, the better the pressure balance. In practice, however, as the width of the cavity is increased, support for the bristles decreases. Also, if the cavity becomes large enough, and the corresponding land portion of the back plate becomes small enough, the high pressure can permanently bend or cut the bristles on the edges of the cavity. Even when passages between the high pressure region and the large cavity are included to vent the cavity to help to balance the pressure, a pressure imbalance may still exist because pressure decreases from the OD to the ID. The known methods or devices to overcome this discrepancy typically involve careful design of the passages or openings, and thus are less than satisfactory. Some conventional brush seals are set forth in U.S. Pat. Nos. 5,401,036, 5,799,972, and 6,231,047, incorporated herein by reference.

### SUMMARY OF THE INVENTION

It is therefore an object of this invention to provide an improved brush seal.

It is a further object of this invention to provide such an improved brush seal exhibiting an improved pressure balance.

It is a further object of this invention to provide such an improved brush seal with increased high pressure capability and improved bristle support.

It is a further object of this invention to provide such an improved brush seal with reduced wear and increased useful life.

The subject invention results from the realization that an improved brush seal is achieved with a back plate for supporting the brush seal bristles that includes at least one spiral groove for better pressure balance.

The subject invention, however, in other embodiments, need not achieve all these objectives and the claims hereof should not be limited to structures or methods capable of achieving these objectives.

This invention features a brush seal including a plurality of bristles, a front plate, and a back plate abutting the bristles, the back plate including at least one spiral groove therein to pressure balance the brush seal. The bristles may have a slant angle and the spiral groove may extend at an angle opposite the slant angle. In one example, the spiral groove may have a depth of between approximately 0.005 to 0.200 inches and a width of between approximately 0.005 and 0.200 inches. The spiral groove may include less than twenty spirals per inch of diameter of the back plate. In one embodiment, the back plate includes an inner diameter and an outer diameter and the back plate further includes a first circular groove proximate the inner diameter. The spiral groove may extend from the first circular groove continuously around the back plate to an area proximate the outer diameter of the back plate. The spiral groove may extend continuously around the back plate at least twice. The brush seal also may include a second circular groove proximate the outer diameter of the back plate, the spiral groove terminating at the second circular groove. The brush seal may include means for connecting the second circular groove proximate the outer diameter of the back plate with an upstream pressure region. The means for connecting may include at least one axial slot connected to at least one radial slot, or the means for connecting may include at least two radial slots connected by at least one axial slot.

In one embodiment, the brush seal may include a plurality of spiral grooves in the back plate. The back plate may further include a first circular groove proximate the inner diameter thereof and a second circular groove proximate the outer diameter thereof. The plurality of spiral grooves may each extend from the second circular groove to the first circular groove. The bristles may have a slant angle and the plurality of spiral grooves may extend at an angle opposite the slant angle.

This invention also features a brush seal including a plurality of bristles, a front plate, and a back plate abutting the bristles. The back plate includes an inner diameter and an outer diameter and a first circular groove proximate the inner diameter. At least one spiral groove extends continuously around the back plate at least twice from the first circular groove to an area proximate the outer diameter of the back plate to pressure balance the brush seal. The bristles may have a slant angle and the spiral groove may extend at an angle opposite the slant angle. In one example, the spiral groove may have a depth of between approximately 0.005 to 0.200 inches and a width of between approximately 0.005 and 0.200 inches, and the spiral groove may include less than twenty spirals per inch of diameter of the back plate. The brush seal may include a second circular groove proximate the outer diameter of the back plate, the spiral groove terminating at the second circular groove. The brush seal may further include means for connecting the second circular groove proximate the outer diameter of the back plate with an upstream pressure region. The means for connecting may include at least one axial slot connected to at least one radial slot, or the means for connecting may include at least two radial slots connected by at least one axial slot. There may be a plurality of spiral grooves in the back plate. The back plate may include a second circular groove proximate the outer diameter of the back plate. The bristles may have a slant angle which may extend at an angle opposite the slant angle.

This invention further features a brush seal including a plurality of bristles, a front plate, and a back plate abutting the bristles. The back plate includes at least one spiral groove therein and a circular groove proximate an outer diameter of the back plate, the spiral groove terminating at the circular groove to pressure balance the brush seal. The back plate may include an inner diameter and a second circular groove proximate the inner diameter. In one example, the bristles may have a slant angle and the spiral groove extends at an angle opposite the slant angle. The spiral groove may have a depth of between approximately 0.005 to 0.200 inches and a width of between approximately 0.005 and 0.200 inches. The spiral groove may include less than twenty spirals per inch of diameter of the back plate. The spiral groove may extend from the second circular groove to the circular groove proximate the outer diameter of the back plate. The spiral groove may extend continuously around the back plate at least twice. The brush seal may further include means for connecting the circular groove proximate the outer diameter of the back plate with an upstream pressure region. The means for connecting may include at least one axial slot connected to at least one radial slot, or the means for connecting may include at least two radial slots connected by at least one axial slot. There may be a plurality of spiral grooves in the back plate, and the back plate may include a second circular groove proximate an inner diameter of the back plate. The plurality of spiral grooves may each extend from the second circular groove to the circular groove proximate the outer diameter of the back plate. The bristles may have a slant angle and the plurality of spiral grooves may extend at an angle opposite the slant angle.

This invention also features a brush seal including a plurality of bristles having a slant angle, a front plate, and a back plate abutting the bristles. The back plate includes a first circular groove proximate the inner diameter of the back plate, a second circular groove proximate the outer diameter of the back plate, and a plurality of spiral grooves each extending at an angle opposite the slant angle from the second circular groove to the first circular groove to pressure balance the brush seal.

### BRIEF DESCRIPTION OF THE DRAWINGS

Other objects, features and advantages will occur to those skilled in the art from the following description of a preferred embodiment and the accompanying drawings, in which:

FIG. 1A is a schematic exploded view of a typical prior art annular brush seal including a front plate and a back plate;

FIGS. 1B and 1C are schematic cross-sectional views of the prior art annular brush seal of FIG. 1A;

FIG. 2 is a schematic cross-sectional view of one example of a brush seal in accordance with the present invention;

FIG. 3 is a schematic front view of one example of a back plate for a brush seal in accordance with the present invention including a single spiral groove;

FIG. 4 is a schematic front view of another example of a back plate for a brush seal of the present invention including a circular groove proximate the inner diameter;

FIG. 5A is a schematic front view of a further example of a back plate for a brush seal of the present invention including circular grooves proximate the inner and outer diameters;

FIG. 5B is a schematic cross-sectional view of a brush seal in accordance with the present invention including the back plate shown in FIG. 5A;

FIG. 6 is a schematic front view of another example of a back plate for a brush seal in accordance with the present invention including a plurality of spiral grooves;

FIGS. 7A and 7B are schematic cross-sectional views of two types of prior art brush seals;

FIG. 7C is a schematic cross-sectional view of one example of a brush seal in accordance with the present invention;

FIG. 7D is a graph of back plate pressure radial distribution for the brush seals of FIGS. 7A-7C;

FIG. 8 is a graph of pressure-induced stiffness for a conventional prior art brush seals versus a brush seal in accordance with the present invention;

FIG. 9A is an enlarged partial schematic front view of a back plate for a brush seal in accordance with the present invention;

FIG. 9B is a schematic cross-sectional view of the back plate of FIG. 9A;

FIG. 10 is a schematic cross-sectional view of one example of a brush seal in accordance with the present invention including an axial slot for pressurizing the back plate spiral groove; and

FIG. 11 is a schematic cross-sectional view of another example of a brush seal in accordance with the present invention including a radial slot for pressurizing the back plate spiral groove.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

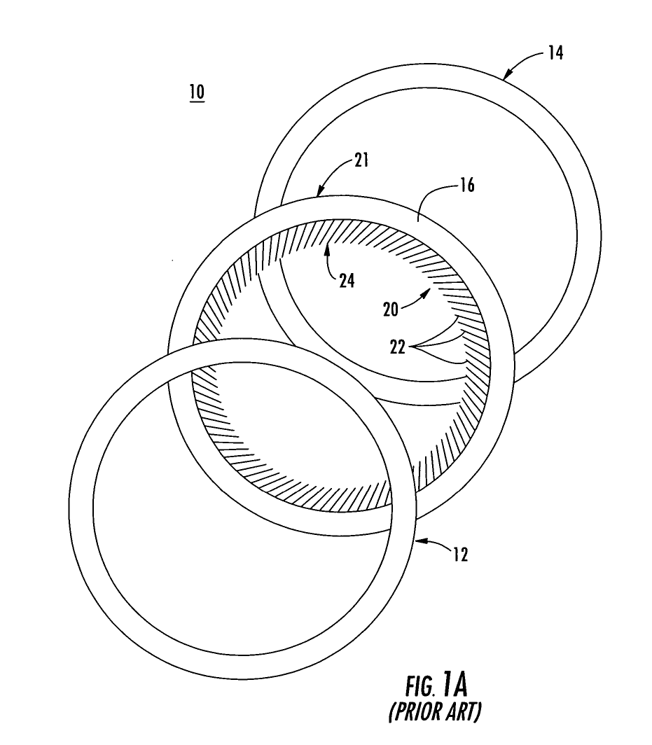

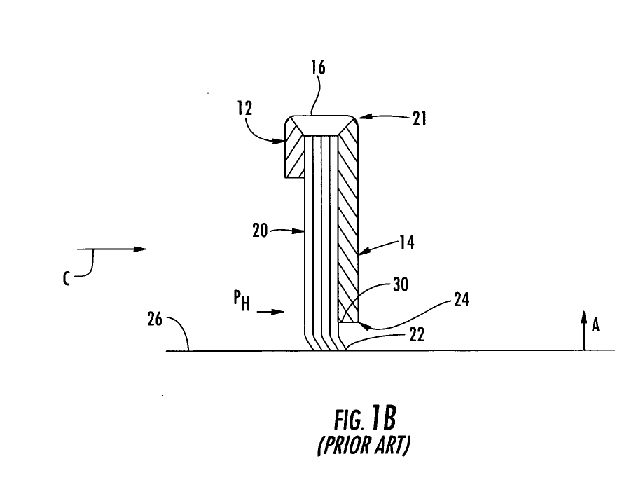

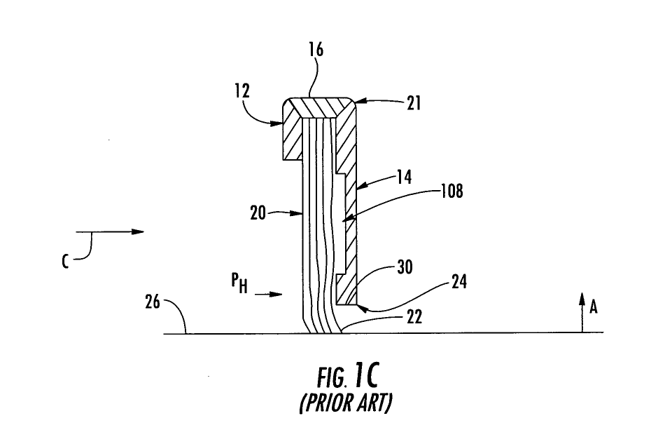

FIG. 1A shows a typical annular brush seal 10 including front plate 12, back plate 14, and retainer 16 holding one end of bristles 20 at outer diameter (OD) 21. Retainer 16 is optional, as bristles 20 can be sandwiched directly between front plate 12 and back plate 14. Free sealing end 22 of bristles 20 at inner diameter (ID) 24 typically rides on a rotating shaft to provide a seal between the shaft and a housing.

As noted in the Background section above, bristles 20 are flexible and thus can withstand radial excursions of rotating shaft 26. Under large pressure loads, there is a higher pressure region P_{H}, FIG. 1B, on the upstream side of bristles 20 in the direction indicated by arrow C. The unbalanced pressure force presses the bristles against the backplate, making the bristle pack much less flexible. Thus, when rotating shaft 26 undergoes a radial excursion in the direction A, this excursion together with the high pressure can cause severe wear and bending of 20 bristles around bottom end 30 of back plate 14 because the bristles are not moving out of the way.

The pressure imbalance can be improved with including an annular cavity 108 in the backplate 14, FIG. 1C, which is the current method used for pressure balance design. With such a cavity, the high pressure area on the backplate extends toward the ID, the more critical region. However, the benefit is limited by the width of the cavity; a wide cavity will reduce support area. The bristles can be cut or permanently bent over the edge of the cavity and the edge of the back plate.

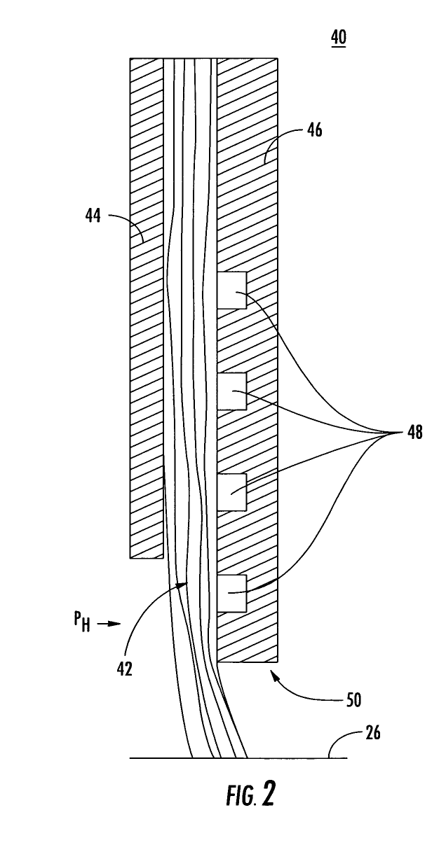

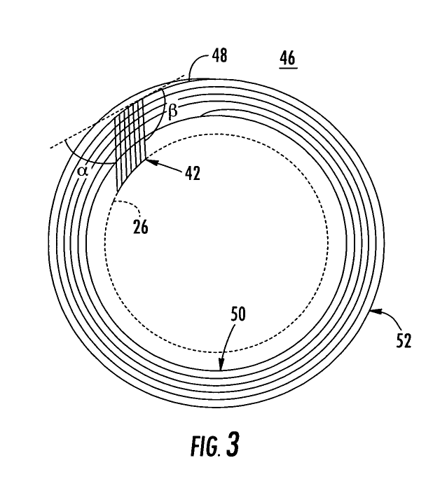

Brush seal 40, FIG. 2, in accordance with the present invention includes plurality of bristles 42, front plate 44 and back plate 46 abutting bristles 42 including at least one spiral groove 48 therein to pressure balance brush seal 40. Spiral groove 48, FIG. 3, may grow counterclockwise or clockwise depending on a particular application. Since there is a strong air flow in spiral groove 48 under high pressure conditions, groove direction can be purposely chosen to either enforce or reduce the pressure blow-down effect. In one example, bristles 42 have a slant angle α. If spiral groove 48 extends at an angle β opposite slant angle α, contact between bristles 42 and rotating shaft 26 is increased. Conversely, if angle β is in the same direction as angle α, i.e. spiral groove 48 is with the bristle slant direction, pressure wash-down is reduced. Although only a few bristles are shown, this is for illustration only, as bristles 42 continue completely around the brush seal.

The spiral groove 48 in FIG. 2 should not be confused with multiple annular grooves in a variation form of FIG. 1C. While the spiral groove creates multiple cavities that are naturally connected, the multiple annular cavities are essentially separated. Multiple annular grooves are not effective because the pressure in the nearest cavity to the back plate ID is still much less than the pressure near the backplate OD. The pressure cascades down from the cavity in the OD area to the cavity near the ID area of the backplate.

With spiral groove 48 on back plate 46, high pressure is driven all the way down to inner diameter 50 of back plate 46. There is increased support for bristles 42, together with increased area on back plate 46, namely spiral groove 48, to extend the high pressure over a larger bristle area. The result is the markedly improved brush seal of the present invention.

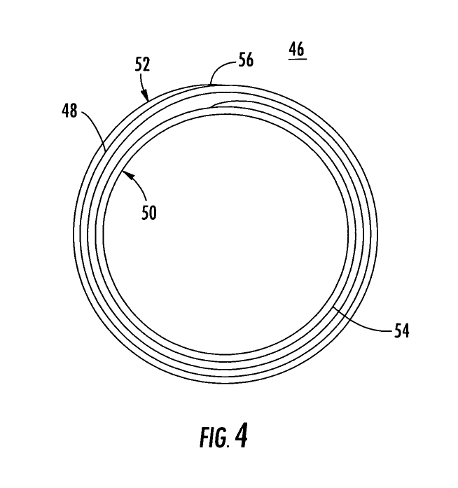

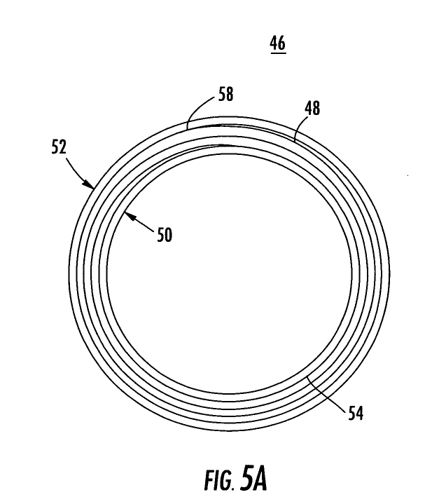

In one example, back plate 46, FIG. 4 also includes circular groove 54 proximate inner diameter 50. In one configuration, spiral groove 48 extends from circular groove 54 around back plate 46 to an area 56 proximate outer diameter 52 of back plate 46. In another configuration, there is also circular groove 58, FIG. 5A, is proximate outer diameter 52 of back plate 46 and spiral groove 48 terminates at circular groove 58. As shown in FIG. 5B, spiral groove 48 preferably extends continuously around back plate 46 at least twice, although this is not a necessary limitation of the invention. For each embodiment described herein, any number of spirals may be used. Preferably, there are less than twenty spirals per inch of back plate diameter d. In FIG. 5B, two spirals are shown.

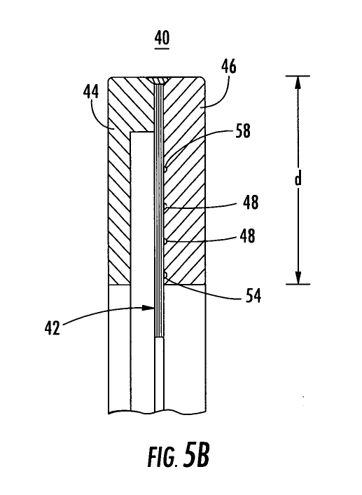

In another example, back plate 46, FIG. 6, includes a plurality of spiral grooves or slant grooves 48, with plurality of spiral grooves or slant grooves 48 each extending from circular groove 58 to circular groove 54. Preferably, bristles 42 have a slant angle α′, and spiral groove 48 extends at an angle β′ opposite slant angle α′ in order to increase contact between bristles 42 and rotating shaft 26 which is partially shown. If angle β′ is with, rather than opposite, slant angle α′, pressure wash-down is reduced. Although only two bristles are shown, bristles 42 continue completely around the brush seal.

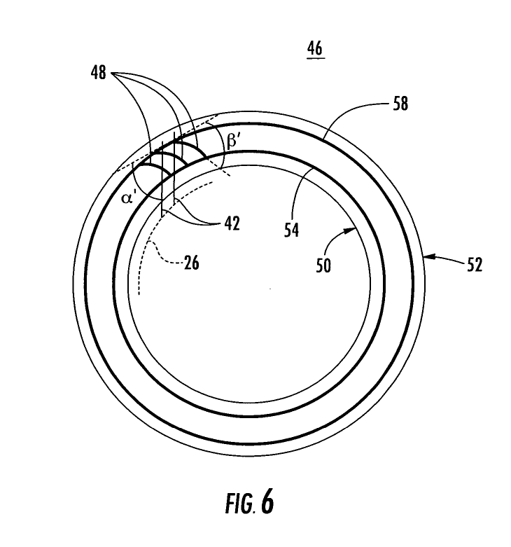

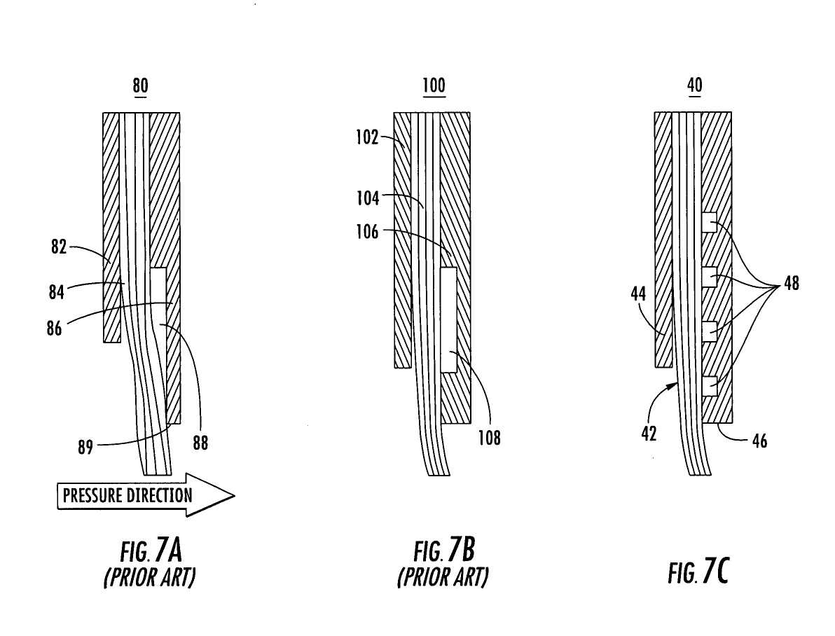

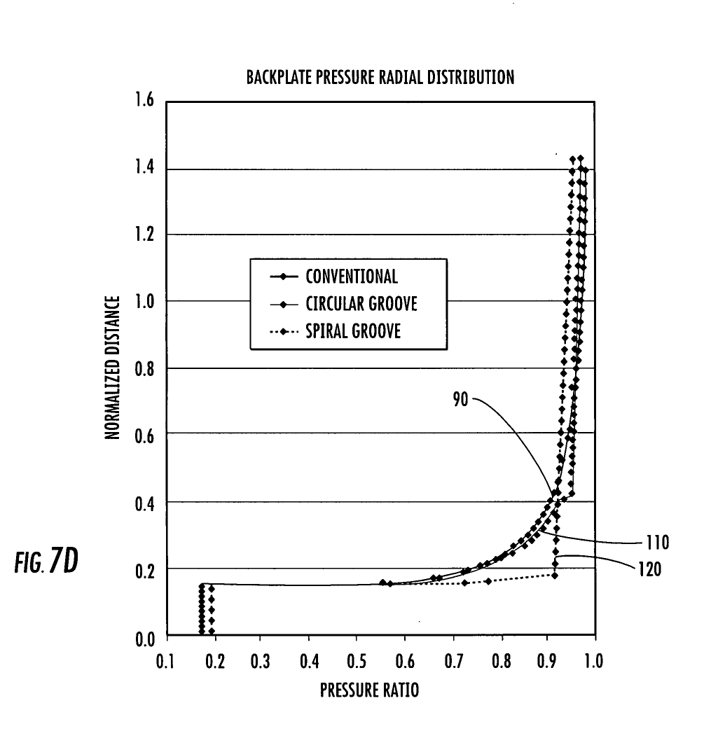

The improved pressure distribution achieved by the present invention is illustrated in FIGS. 7A-7D. FIGS. 7A-7B show two prior art brush seals, while FIG. 7C shows an example of a brush seal in accordance with the present invention. FIG. 7D shows a comparison of the back plate pressure radial distribution for each of these types of brush seals.

Prior art brush seal 80, FIG. 7A, includes front plate 82, bristles 84 and planar back plate 86, which under high pressure results in void 88 and bending of bristles 84 at bottom end 89 of back plate 86. The back plate pressure radial distribution 90, FIG. 7D associated with prior art brush seal 80 indicates the lack of pressure balance.

Prior art brush seal 100, FIG. 7B, includes front plate 102, bristles 104, and back plate 106 including cavity 108. The associated back plate pressure radial distribution 110, FIG. 7D, indicates some increase in pressure balance. However, as noted in the Background section above, the tradeoffs for a large cavity such as cavity 108, FIG. 7C, include less support for bristles 104 adjacent the cavity 108.

In contrast, brush seal 40, FIG. 7C, of the present invention including bristles 42, front plate 44 and back plate 46 including at least one spiral groove 48 has a much more balanced back plate pressure distribution 120, FIG. 7D.

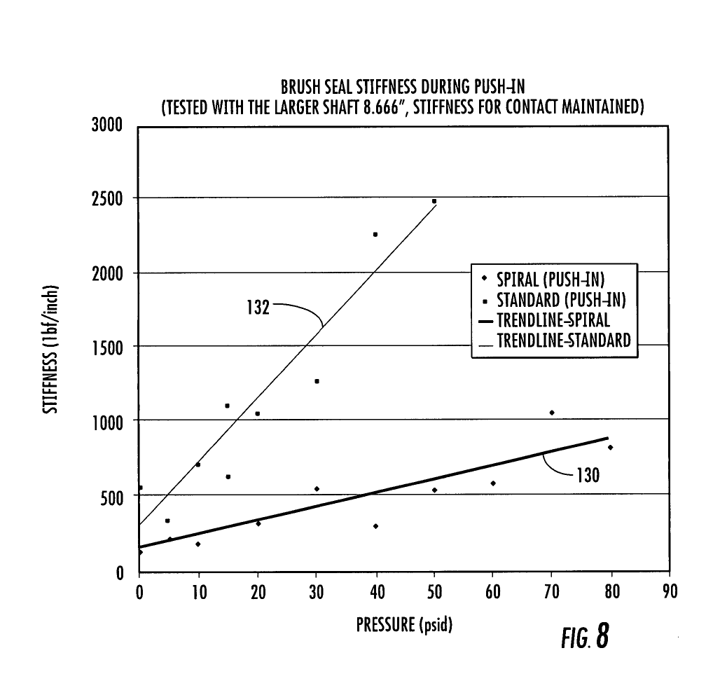

In addition, trend line 130, FIG. 8, for a brush seal in accordance with the present invention indicates decreased stiffness compared to a conventional brush seal, the latter indicated at trend line 132. In other words, the present invention has much less pressure-induced stiffness of the bristles due to the sharp increase in pressure balance. In fact, even through the air leakage through the region between the bristle pack and the backplate may increase in the present invention, the overall leakage is actually less because of better adaptivity of the bristles to the openings. With the present invention, air leakage between the bristles and the rotating shaft under maximum pressure conditions is about one-half of a conventional brush seal as indicated by prototype test results.

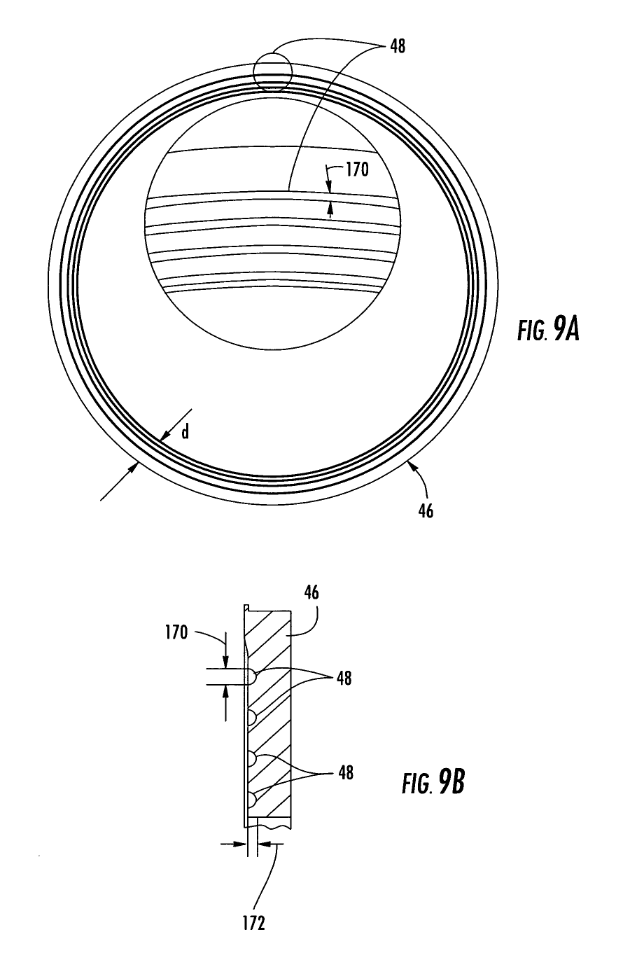

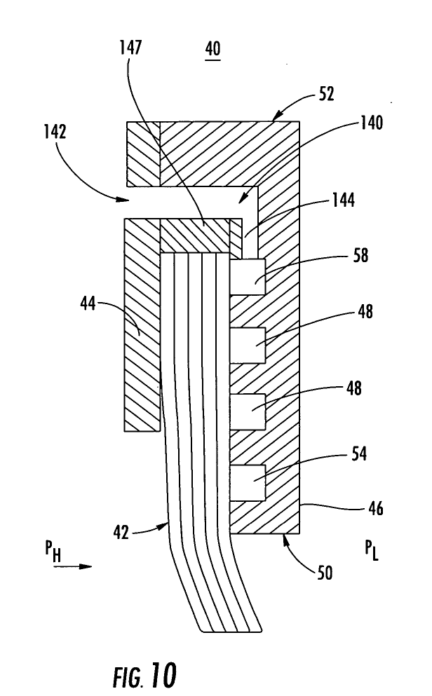

Although the precise dimensions of the spiral groove in the back plate of a brush seal in accordance with the present invention can vary depending on the desired use of the brush seal, typical dimensions for spiral groove 48 are shown in FIGS. 9A and 9B for one specific application. In this example, spiral groove 48 has width 170 between approximately 0.005 inches and 0.200 inches, and a depth 172 between approximately 0.005 inches and 0.200 inches. As noted elsewhere herein, spiral groove 48 preferably includes less than twenty spirals per inch of diameter d of back plate 46.

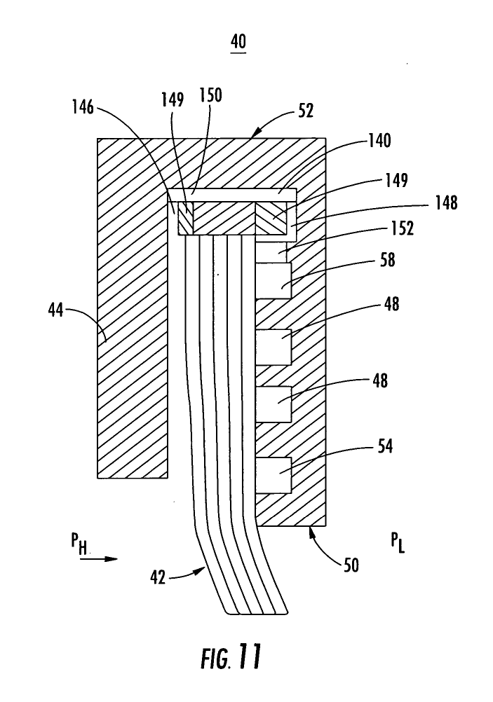

In general, pressure distribution on typical brush seal back plates is not uniform. One reason for this is the fact that pressure slowly declines from the OD to the ID. With the brush seal of the present invention, the spiral groove feeds air from the OD region to the ID region of the back plate, improving the pressure balance from OD to ID and between the upstream high pressure region P_{H} and the region behind the bristles on the downstream side. However, the air in the OD region comes principally from the leaking path in the bristles root area, i.e. the leakage flow from the upstream higher pressure area through the bristles. Thus, the air used to pressurize the back plate may not be sufficient if, for example, the bristle pack is thick and restrictive. Pressurization may be enhanced, however, and FIGS. 10 and 11 show ways to pressurize the back plate in order to enforce the effects of the back plate spiral groove of the present invention.

To bring about this enhanced pressurization in one example, brush seal 40, FIGS. 10 and 11 includes means for connecting circular groove 58 proximate outer diameter 52 of back plate 46 with upstream pressure region P_{H}. In FIG. 10, the means for connecting 140 includes at least one axial slot or hole 142 and at least one radial slot 144 in conjunction therewith to connect upstream pressure region P_{H} with circular groove 58. This means for connecting is particularly useful for brush seals where bristles 42 are held together by weld 147.

In another example, the means for connecting includes at least two radial slots 146 and 148, FIG. 11 and axial slot 150 between and connecting radial slots 146 and 148. There may be another radial slot 152 to connect upstream high pressure region P_{H} with circular groove 58, or radial slot 152 may be part of radial slot 148. This means for connecting is particularly useful for brush seals where bristles 42 are held together by retainer or bristle strips 149.

While FIGS. 10 and 11 illustrate two ways of connecting upstream pressure region P_{H} with a circular groove proximate the outer diameter, thus further pressurizing the back plate, these are not limitations on the subject invention, and other means for connecting may be utilized as necessary for a particular application. Also, for embodiments of the brush seal in accordance with the present invention where there is at least one spiral groove without associated circular groove(s), e.g. FIG. 2, or where there is at least one spiral groove 48 and a single circular groove 54 proximate inner diameter 50, FIG. 4, the means for connecting may be directly between spiral groove 48 at the OD and the upstream pressure region P_{H}.

With the spiral groove back plate, the brush seal of the present invention thus exhibits improved pressure balance, increased high pressure capability, improved bristle support, and reduced wear, thereby extending the useful life of the brush seal.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A brush seal comprising:
a plurality of bristles;
a front plate; and
a back plate abutting the bristles, the back plate including at least one spiral groove therein to pressure balance the brush seal.

2. The brush seal of claim 1 in which the back plate includes an inner diameter and an outer diameter and the back plate further includes a first circular groove proximate the inner diameter.

3. The brush seal of claim 2 in which the spiral groove extends from the first circular groove continuously around the back plate to an area proximate the outer diameter of the back plate.

4. The brush seal of claim 3 in which the spiral groove extends continuously around the back plate at least twice.

5. The brush seal of claim 3 further including a second circular groove proximate the outer diameter of the back plate and the spiral groove terminates at the second circular groove.

6. The brush seal of claim 5 further including means for connecting the second circular groove proximate the outer diameter of the back plate with an upstream pressure region.

7. The brush seal of claim 6 in which the means for connecting includes at least one axial slot connected to at least one radial slot.

8. The brush seal of claim 6 in which the means for connecting includes at least two radial slots connected by at least one axial slot.

9. The brush seal of claim 1 in which there are a plurality of spiral grooves in the back plate.

10. The brush seal of claim 9 in which the back plate further includes a first circular groove proximate the inner diameter thereof and a second circular groove proximate the outer diameter thereof.

11. The brush seal of claim 10 in which the plurality of spiral grooves each extend from the second circular groove to the first circular groove.

12. The brush seal of claim 11 in which the bristles have a slant angle and the plurality of spiral grooves extend at an angle opposite the slant angle.

13. The brush seal of claim 1 in which the bristles have a slant angle and the spiral groove extends at an angle opposite the slant angle.

14. The brush seal of claim 1 in which the spiral groove has a depth of between approximately 0.005 to 0.200 inches.

15. The brush seal of claim 1 in which the spiral groove has a width of between approximately 0.005 and 0.200 inches.

16. The brush seal of claim 1 in which the spiral groove includes less than twenty spirals per inch of diameter of the back plate.

17. A brush seal comprising:
a plurality of bristles;
a front plate; and
a back plate abutting the bristles, the back plate including:
an inner diameter and an outer diameter, and
a first circular groove proximate the inner diameter; and
at least one spiral groove extending continuously around the back plate at least twice from the first circular groove to an area proximate the outer diameter of the back plate to pressure balance the brush seal.

18. The brush seal of claim 17 further including a second circular groove proximate the outer diameter of the back plate and the spiral groove terminates at the second circular groove.

19. The brush seal of claim 18 further including means for connecting the second circular groove proximate the outer diameter of the back plate with an upstream pressure region.

20. The brush seal of claim 19 in which the means for connecting includes at least one axial slot connected to at least one radial slot.

21. The brush seal of claim 19 in which the means for connecting includes at least two radial slots connected by at least one axial slot.

22. The brush seal of claim 17 in which there are a plurality of spiral grooves in the back plate.

23. The brush seal of claim 22 in which the back plate further includes a second circular groove proximate the outer diameter of the back plate.

24. The brush seal of claim 17 in which the bristles have a slant angle and the spiral groove extends at an angle opposite the slant angle.

25. The brush seal of claim 17 in which the spiral groove has a depth of between approximately 0.005 to 0.200 inches.

26. The brush seal of claim 17 in which the spiral groove has a width of between approximately 0.005 and 0.200 inches.

27. The brush seal of claim 17 in which the spiral groove includes less than twenty spirals per inch of diameter of the back plate.

28. A brush seal comprising:
a plurality of bristles;
a front plate; and
a back plate abutting the bristles, the back plate including at least one spiral groove therein and a circular groove proximate an outer diameter of the back plate, the spiral groove terminating at the circular groove to pressure balance the brush seal.

29. The brush seal of claim 28 in which the back plate includes an inner diameter and a second circular groove proximate the inner diameter.

30. The brush seal of claim 29 in which the spiral groove extends from the second circular groove to the circular groove proximate the outer diameter of the back plate.

31. The brush seal of claim 30 in which the spiral groove extends continuously around the back plate at least twice.

32. The brush seal of claim 28 further including means for connecting the circular groove proximate the outer diameter of the back plate with an upstream pressure region.

33. The brush seal of claim 32 in which the means for connecting includes at least one axial slot connected to at least one radial slot.

34. The brush seal of claim 32 in which the means for connecting includes at least two radial slots connected by at least one axial slot.

35. The brush seal of claim 28 in which there are a plurality of spiral grooves in the back plate.

36. The brush seal of claim 28 in which the back plate further includes a second circular groove proximate an inner diameter of the back plate.

37. The brush seal of claim 36 in which the plurality of spiral grooves each extend from the second circular groove to the circular groove proximate the outer diameter of the back plate.

38. The brush seal of claim 37 in which the bristles have a slant angle and the plurality of spiral grooves extend at an angle opposite the slant angle.

39. The brush seal of claim 28 in which the bristles have a slant angle and the spiral groove extends at an angle opposite the slant angle.

40. The brush seal of claim 28 in which the spiral groove has a depth of between approximately 0.005 to 0.200 inches.

41. The brush seal of claim 28 in which the spiral groove has a width of between approximately 0.005 and 0.200 inches.

42. The brush seal of claim 28 in which the spiral groove includes less than twenty spirals per inch of diameter of the back plate.

43. A brush seal comprising:
a plurality of bristles having a slant angle;
a front plate; and
a back plate abutting the bristles, the back plate including:
a first circular groove proximate the inner diameter of the back plate,
a second circular groove proximate the outer diameter of the back plate, and
a plurality of spiral grooves each extending at an angle opposite the slant angle from the second circular groove to the first circular groove to pressure balance the brush seal.
